(19) United States
(12) Patent Application Publication
(10) Pub. No.: US 2005/0044363 A1
(43) Pub. Date: Feb. 24, 2005

(54) Trusted remote firmware interface

(76) Inventors: Vincent J. Zimmer, Federal Way, WA (US); Michael A. Rothman, Gig Harbor, WA (US)

Correspondence Address: R. Alan Burnett;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/646,606

(22) Filed: Aug. 21, 2003

(51) Int. Cl. H04L 9/00

(52) U.S. Cl. 713/170

(57) ABSTRACT

A method and system to access the firmware of a remote computer via a trusted process. The remote computer receives a request to perform a firmware service from a caller computer via a network. The caller computer and remote computer then interact to authenticate the caller computer, and, optionally, the remote computer. If authentication is successful, the firmware service is performed by the remote computer, otherwise access to the firmware service is denied. A cipher negotiation may also be employed to agree upon an encryption scheme to be used to encrypt and decrypt data traffic sent between the caller and remote computers. In one embodiment, the operations of the method are performed via execution of firmware of the remote computer that is configured in accordance with the Extensible Firmware Interface (EFI) framework standard.

### FIELD OF THE INVENTION

The field of invention relates generally to computer systems and, more specifically but not exclusively, relates to accessing the firmware of a remote computer system using a trusted remote firmware interface (TRFI).

### BACKGROUND INFORMATION

During a computer system startup, the computer system is self-tested and initialized through loading and execution of system firmware. Under personal computer (PC) architectures, this firmware is commonly referred to as the system's Basic Input/Output System (BIOS). In a typical PC architecture, the BIOS is the firmware that runs between the processor reset and the first instruction of the Operating System (OS) loader. The BIOS also acts as an interface between software and hardware components of a computer system during the OS runtime. As computer systems have become more sophisticated, the operational environment between the application and OS levels and the hardware level is generally referred to as the firmware or the firmware environment.

Today's systems allow for remote access to computers over a network. For example, Wired for Management (WfM) is a specification from the Intel Corporation that describes the performance of certain computer configuration and maintenance functions over a network. Using WfM, the installed hardware and software of a remote computer can be determined and monitored in real time by another computer, such as a server. A feature called remote wakeup (RWU) minimizes unnecessary use of system bandwidth by keeping unused machines online only when they are needed according to a pre-planned schedule. Access to distant computers can be monitored and regulated. A server can access a remote computer to perform tasks such as repair corrupted files and programs, update the operating system, update virus programs, back up files and monitor the remote computer's health.

While the concept of remote invocation has been implemented in operating system environments, access to the firmware of a remote computer regardless of the presence of an operating system currently has limited capabilities. Without the ability to have flexible entry into the firmware infrastructure of the remote computer, a caller computer (e.g., a server) is dependent upon the data that the firmware of the remote computer is programmed to provide the caller. In some networks, the remote's firmware is limited to network boot operations and echoing of the remote system screen data at the caller's monitor. Other remote systems have specific boot-agents that communicate back to their caller in some proprietary fashion. However, these systems are vendor-specific and do not allow a single program to control remote systems in a similar manner when the remote systems come from a variety of vendors.

Another concern for remote firmware access is trust. A rogue server might be programmed to intentionally corrupt the firmware on remote clients, or otherwise produce unwanted results. Accordingly, a mechanism should exist to authenticate calling computers prior to permitting access to firmware services provided by remote computers.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating an out-of-band communication process between a caller computer and a remote computer in accordance with one embodiment of the present invention;

FIG. 2 is a flowchart illustrating the logic and operations performed by one embodiment of the invention to set up a trusted access to firmware of a remote computer;

FIG. 3 is a schematic diagram illustrating a network configuration including a plurality of management servers communicatively coupled to a plurality of clients, for describing the authentication process of FIG. 4;

FIG. 4 is a schematic flow diagram illustrating operations performed during an authentication process in accordance with one embodiment of the invention;

FIG. 5 is a is a schematic diagram illustrating the various execution phases that are performed in accordance with the extensible firmware interface (EFI) framework under which embodiments of the invention may be deployed;

FIG. 6 is a block schematic diagram illustrating various components of the EFI system table corresponding to the EFI framework;

FIG. 7 is a flowchart illustrating a remote firmware access process;

FIG. 8 is a schematic diagram illustrating a computer system that may be used to practice embodiments of the present invention;

### DETAILED DESCRIPTION

Embodiments of a method to access firmware of a remote computer and computer apparatus for implementing the method are described herein. In the following description, numerous specific details are set forth, such as embodiments pertaining to the Extensible Firmware Interface (EFI) framework standard, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the invention, a mechanism is disclosed to allow an agent to request firmware services from a remote computer in a programmatic and secure manner. The mechanism, known as the Trusted Remote Firmware Interface (TRFI), allows one to exercise program code in the firmware environment of a remote computer under the direct control of another trusted computer via a predefined interface. A caller computer, such as a trusted server, now has the ability to access data and initiate firmware services of a remote machine, such as a network client. After the server and/or client are authenticated, requested tasks (i.e., firmware services) are performed under the control of firmware of the remote computer and independent of the remote computer's operating system. In one embodiment, this is facilitated, in part, by an out-of-band (OOB) communication scheme that operates in a manner that is transparent to the operation system running on the remote computer. Thus, through TRFI, the remote computer can process tasks assigned by a caller during pre-boot, OS runtime, or even after the operating system has crashed.

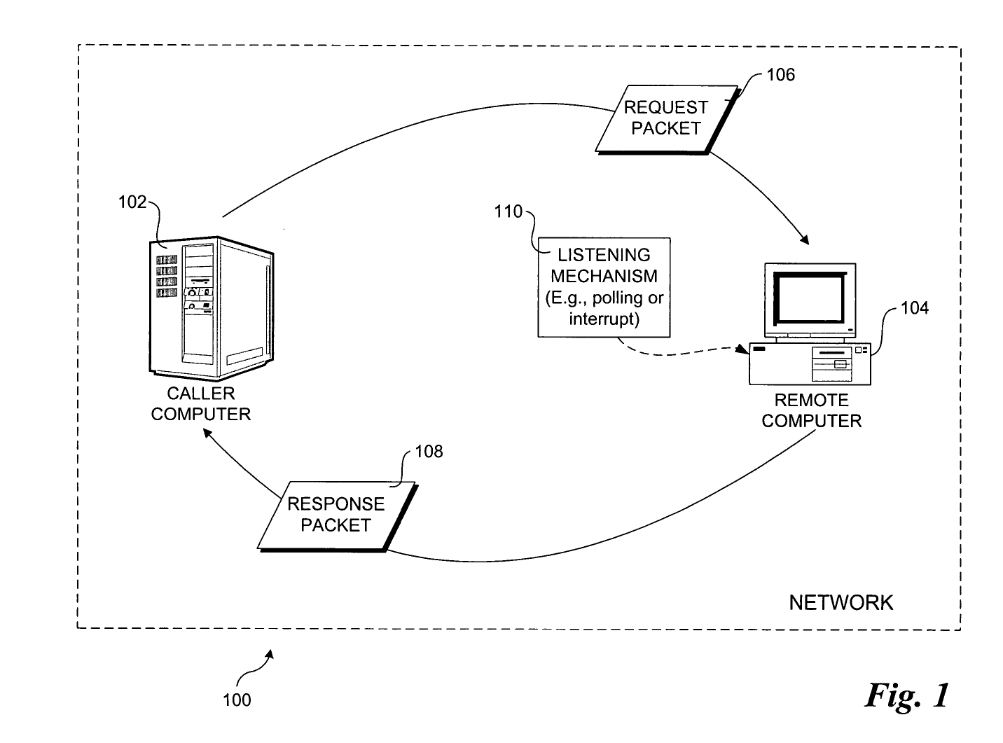

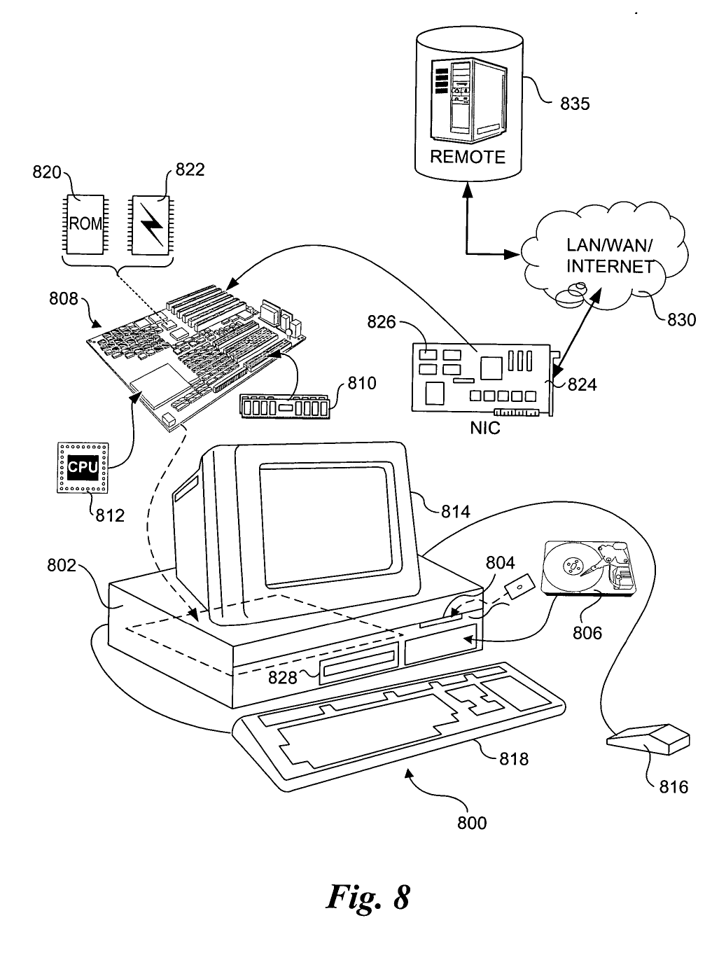

As an overview, reference is made to FIG. 1, which illustrates a simplified remote communication process between a caller computer 102 and a remote computer 104 via a network 100. Generally, caller computer 102 and remote computer 104 include, but are not limited to, a personal computer, a network server, a network workstation, a portable computer, a handheld or palmtop computer, a personal digital assistant (PDA), or the like. In one embodiment, caller computer 102 and remote computer 104 are configured in a similar manner to an exemplary computer system discussed below in conjunction with FIG. 8. In one embodiment, the caller computer 102 is a server and remote computer 104 is a client in network 100. The network 100 is shown with one caller and one remote for clarity, but it will be understood that network 100 could contain more computer systems, each computer system capable of acting as a caller or a remote computer.

Caller computer 102 sends a request packet 106 onto the network 100 addressed for remote computer 104. In one embodiment, the request packet 106 is sent in real-time. In another embodiment, the request packet 106 is a scheduled event that occurs automatically according to a pre-planned schedule. After remote computer 104 receives the request packet 106, the remote computer 104 performs the action (via an appropriate firmware service) as defined in the request packet 106. After completing the requested action, the remote computer 104 prepares a response packet 108. The response packet 108 may contain data requested by the caller computer 102 or simply confirmation that the requested task was successfully completed or failed due to some error.

FIG. 1 also shows a listening mechanism 110 that is part of remote computer 104 and is the manner by which the remote computer 104 receives request packets. The communications between the caller and remote computer are facilitated via an out-of-band channel—that is, a communication means that operates independent of an operating system running (or to be run) on the remote computer. In one embodiment, remote computer 104 uses a polling mechanism to listen for request packets; while in another embodiment, the remote computer uses an interrupt mechanism. In a polling implementation, the remote computer periodically checks a particular place to see if it has received a request packet. In one embodiment, the remote determines if a Network Interface Card /Controller (NIC) has received and stored a request packet. In another embodiment, the remote checks a Universal Asynchronous Receiver/Transmitter (UART) to determine if it has received and stored a request packet from its serial port connection. If the remote determines it has received a packet, then the remote's firmware processes the request accordingly and sends a response packet back to the caller. If the remote has not received a request packet, then the remote's firmware continues performing other duties as necessary. The firmware will continually check for a request packet after a pre-determined time period.

In an interrupt implementation, the receipt of a request packet at the remote computer 104 creates an interrupt. The remote's firmware stops its current task to handle the request packet and send a response packet back to the caller. In one embodiment, the request packet signals a System Management Interrupt (SMI) for the remote to enter a System Management Mode (SMM).

SMM is a special mode for handling system wide functions and is intended for use only be system firmware, and not by an operating system or an application. When SMM is invoked through an SMI, the processor saves the current state of the processor and switches to a separate operating environment contained in system management random access memory (SMRAM). While in SMM, the processor executes SMI handler code to perform operations. When the SMI handler has completed its operations, it executes a resume instruction. This instruction causes the processor to reload the saved state of the processor, switch back to protected or real mode, and resume executing the interrupted application or OS tasks.

It will be understood that the request packet 106 can be received and implemented by the remote computer 104 independent of the state of the OS because the request packet is read and executed under the control of the remote's firmware. For example, a system administrator wishes to remotely debug a program that is installed on a plurality of remote computers on a network. The system administrator writes a script and uses a Telnet application to contact a group of remote computers and request each remote to report the contents of a particular memory address.

In another example, a system administrator pushes a firmware update to a group of remotes on a network. The firmware update execution file is included in the request packet sent to each remote. After receiving the request packet, each remote computer loads and executes the firmware update. The response packet from each remote then informs the system administrator whether the firmware update installed successfully or encountered a problem.

In another example, a system administrator is alerted that the OS running on a remote computer has become hung. In response, the system administrator sends a request packet from the server to the hung remote. The request packet asks the remote's firmware to perform a core dump and send the results back to the server. In one embodiment, the core dump captures the settings of the remote such as the memory contents, the processor settings, device settings, and the like. Even though the OS has crashed, the request packet can still be answered by the remote because the request packet is processed in the firmware environment. After the core dump is sent to the server in a response packet, the system administrator resets the remote through another TRFI packet. Thus, the system administrator can return the remote computer to service and still be able to analyze the core dump at a more convenient time.

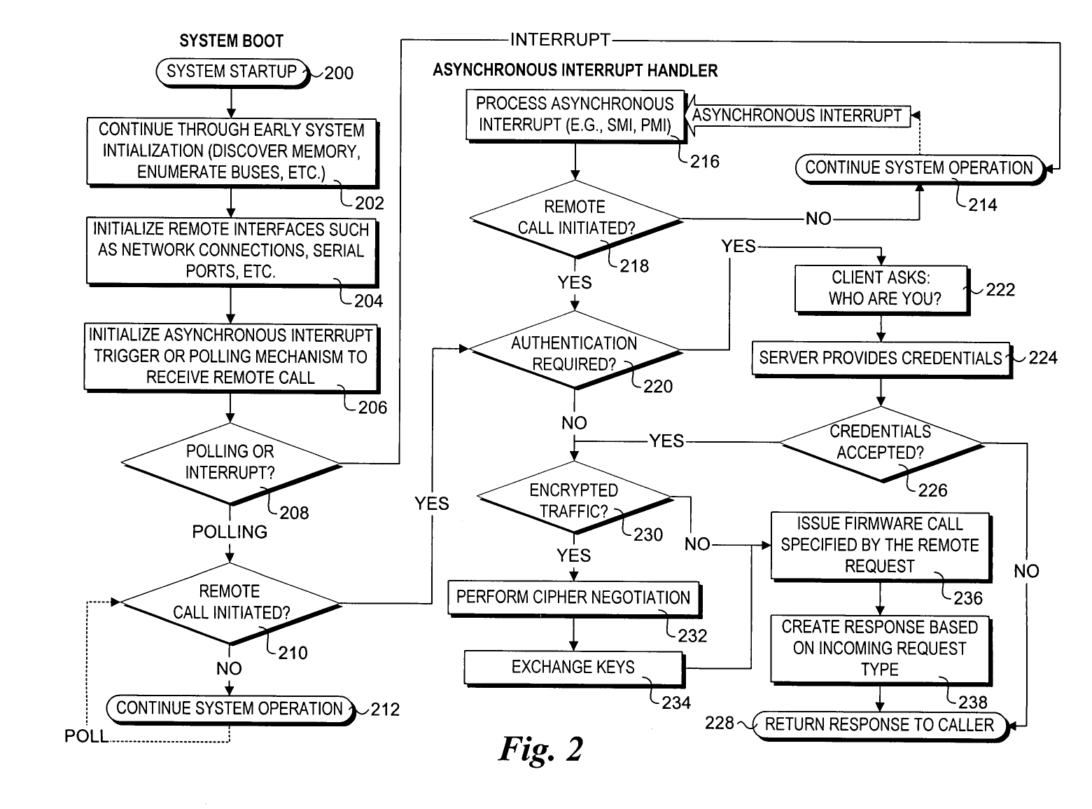

According to an aspect of the invention, TRFI provides a secure mechanism for accessing firmware services provided through execution of firmware on a remote machine. A flowchart illustrating logic and operations performed under a TRFI process in accordance with one embodiment of the present invention under which security is provided by an authentication process is shown in FIG. 2. The process begins in a block 200, which corresponds to a system startup event, i.e., a cold boot or a system reset of a remote computer.

In response to the startup event, pre-boot initialization of the remote computer will begin through loading and execution of system boot instructions stored in the computer system BIOS firmware, as depicted by a block 202. In one embodiment, the system boot instructions will begin initializing the platform by conducting a Power-On Self-Test (POST) routine, initializing system board functions, checking for any expansion boards that hold additional BIOS code, and loading such BIOS code if any is found. Other early system initialization operations include discovery and configuration of memory, enumeration of buses (e.g., PCI buses), and other common operations well-known to those skilled in the computer arts.

During the system startup, a remote interface, such as a network connection, serial port, etc., is initialized, as shown in a block 204. At this point, the remote computer is able to communicate with a network and is eligible to receive request packets from a caller computer. Continuing to a block 206, the mechanism to listen for request packets is initialized. As discussed above, in one embodiment, the listening mechanism employs polling, while in another embodiment the listening mechanism is facilitated via an interrupt scheme.

At this point, the logic of the flowchart branches depending on the type of listening mechanisms that is employed, as shown by a decision block 208. If polling is employed, the logic proceeds to a decision block 210 in which a determination is made to whether a remote call has been initiated. As shown by a continuation block 212 and a polling loop, this determination is made for each polling period.

If the listening mechanism is based on an interrupt scheme, the logic proceeds to a continuation block 214, which indicates that normal system operations are continued until an asynchronous interrupt, such as a SMI or PMI signal is received. In response, the interrupt is initially processed by an interrupt handler in a block 216. During this process, a determination is made in a decision block 218 to whether a remote call has been initiated. If not, the logic returns to continuation block 214 to wait for the next interrupt.

In response to a determination that a remote call has been initiated by either of decision blocks 210 or 218, a determination is made in a decision block 220 to whether authentication is required. If the answer is YES, an authentication process is performed. In short, the authentication process is designed to provide a mechanism via which a caller server may be identified with substantial certainty. Upon successful authentication, the caller is enabled to interact with the client.

In the illustrated embodiment, the authentication process starts in a block 222 with the client sending a message to the caller requesting the caller to identify itself. In return, the server provides authentication credentials in a block 224. A determination is then made in a decision block 226 to whether the credentials are accepted. If the credentials are not accepted, a corresponding response is returned to the caller in an end block 228. Further details of the operations of block 222, 224 and 226 are discussed below.

If the credentials are accepted, the logic proceeds to a decision block 230 in which a determination is made to whether traffic between the client and caller (e.g. server) is to be encrypted. If it is, a cipher negotiation is performed in a block 232, and keys are exchanged in a block 234. At this point, an agreed-upon communication scheme is established to enable remote firmware access. As an overview, these operations include issuing a firmware call specified by a remote request in a block 236 and creating a response based on the incoming request type in a block 238. Further details of the remote firmware access operations are described below.

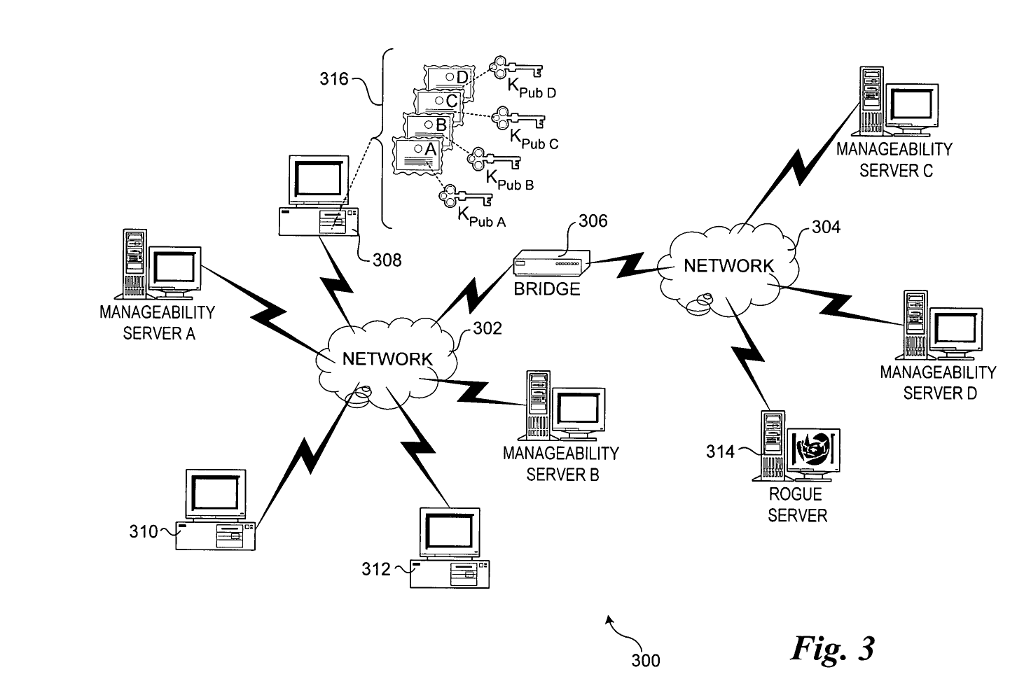

An exemplary network configuration 300 under which an authentication scheme in accordance with one embodiment is depicted is shown in FIG. 3. The network configuration includes two LANs 302 and 304 connected by a bridge (e.g., switch, router, etc.) 306. A plurality of computers are linked in communication via LAN 302, including clients 308, 310 and 312, and manageability servers A and B. Likewise, LAN 304 links a plurality of computers in communication, including manageability servers C and D, and a rogue server 314.

Under the illustrated authentication scheme, each client 308, 310, and 312 stores an access list 316 identifying manageability servers that are to be enabled to access that client. In one embodiment, the management servers are identified by corresponding authentication certificates A, B, C, and D. In their simplest form, authentication certificates contain a public key and a name. As commonly used, a certificate also contains an expiration date, information identifying the certifying authority (CA) that issued the certificate (e.g., the network manager), a unique identifier (e.g., serial number), and perhaps other information. Most importantly, a certificate also contains a digital signature of the certificate issuer. The most widely accepted format for certificates is defined by ITU (International Telecommunications Union)-T X.509 international standard. Accordingly, in one embodiment authentication certificates A-D comprise ITU-T X.509 certificates. Other types of certificates, such as those based on PKIX, PGP and SKIP may also be used.

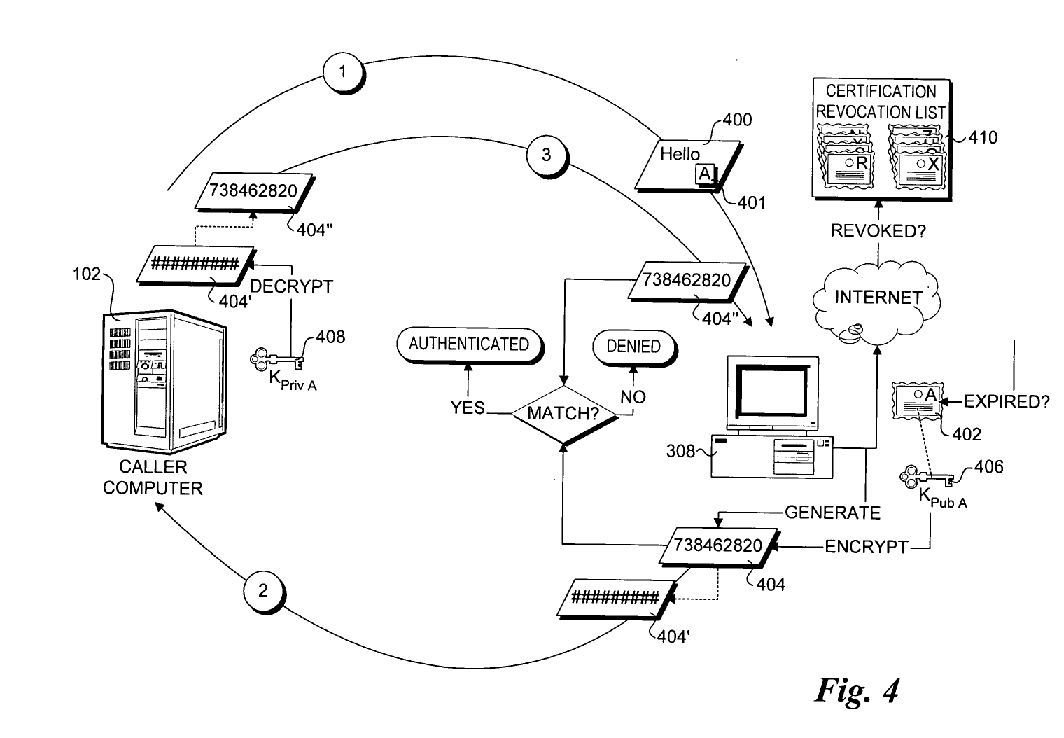

In general, one of many well-known authentication schemes may be employed to authenticate the calling computer. These include Transport Layer Security (TLS)-based schemes, such as TLS over UDP, TLS over TCP/IP, and TLS using EAP. Details of TLS are contained in RFC 2246. One such implementation is illustrated in FIG. 4.

The authentication process of FIG. 4 begins by sending a “hello” message or packet 400 from caller computer 102 to client 308. The “hello” message includes indicia 401 identifying which server sent the message (e.g., a server name included in the server's authentication certificate). With respect to the network configuration of FIG. 3, the illustrated example supposes “hello” message 400 was sent from manageability server A, which operates as caller computer 102. Upon receipt of the message, client 308 extracts indicia 401 and matches it with a certificate 402 from among the certificates in its access list 316. If it does not find a certificate in its access list 316 that corresponds to the identity provided by indicia 402, the authentication process aborts, and the caller computer is prevented from accessing the remote computer.

Next, client 308 generates a random number 404 and encrypts the random number with a public key (Kpub A) 406 extracted from certificate 402 to form an encrypted random number 404′. The encrypted random number is then sent to caller computer 102. This comprises an authentication challenge. In response to the challenge, caller computer 102 employs its private key (Kpriv A) 408 to decrypt encrypted random number 404′, yielding a decrypted random number 404″. The decrypted random number is then returned to client 308. Upon receiving the decrypted random number, the remote computer compares it to the random number that was originally generated. If there is a match, caller computer 102 is authenticated. If not, the authentication process is aborted, denying access by caller computer 102.

As a further option, the validity of the certificate may be checked. In general, certificates are issued by CA's and carry an expiration date. This is to ensure that a given public key is in the public domain for a limited duration. Accordingly, a first validity check is to check the expiration date on the certificate to verify it has not expired. At the same time, certificates may be revoked for one or more reasons. Since certificates may be widely distributed, there is no feasible mechanism for directly apprizing a certificate owner that a certificate has been revoked. One way this problem is addressed is by providing an Internet site (e.g., Verisign) that hosts a certification revocation list 410. This list can be checked by client 308 to verify certificate 402 has not been revoked.

Now suppose that the initial “hello” message was sent by rogue server 314 rather than one of the manageability servers identified by a corresponding certificate from among client 308's access list 316. It is possible that rogue server can overcome the first check by impersonating one of the manageability servers, leading to the authentication challenge. As before, client 308 will generate random number 404, encrypt it with certificate 402's public key 406, and send encrypted random number 404′ to rogue server 314. In response to receiving this authentication challenge, rogue server 314 may attempt to decrypt encrypted random number 404′. However, since rogue server 314 does not have a copy of private key 408, it is prevented from decrypting the random number. Thus, there is no way the rogue server can meet the authentication challenge, and thus will be denied access to client 308.

As another option, a manageability server may authenticate a client using a similar scheme to that illustrated in FIG. 4. In this instance, however, the management server would issue the authentication challenge rather than the client. Under another embodiment, each client is provided with a certificate signed by the management server using its private key. In response to the authentication challenge, the client would submit its certificate to the server. The server, which maintains its own access list, would authenticate the certificate via a signature check, and then compare the identify contained in the certificate with the client identities contained in the access list. If the certificate is authenticated and an identity match is found, the client would be allowed to interact with the manageability server.

Once a manageability server has been authenticated (corresponding to a YES result from decision block 226), the communicating parties may negotiate to send data using an encryption scheme, as discussed above with reference to decision block 230 and blocks 232 and 234. Cipher negotiations of this type are well-known in the encryption art. In accordance with one scheme, the client tells the caller (e.g., manageability server) which cipher algorithms it supports (e.g., symmetric ciphers, such as 3DES, AES, RC4, etc.) The two parties negotiate with the algorithm that is strongest and each support. Typically, traffic sent between the communicating parties will be encrypted using either an asymmetric key pair, or a symmetric key. In some instances, respective shared keys or key pairs will be used for each direction. For further protections, keys are often employed on a session-only basis—that is, new keys are generated for each communication session.

In order to effect each of the foregoing schemes, the key or keys need to be agreed upon and exchanged, as necessary. Generally, keys should be exchanged in a manner that doesn't allow outsiders to see the keys. This is especially true when a shared symmetric key is used, and private keys are not to be sent to other parties over networks. One way to securely exchange keys is to send the key in an encrypted form. Since the respective manageability server and client each have one key of an asymmetric key pair already, these keys may be directly used for encrypted traffic in one embodiment. More commonly, session keys will be generated. However, the existing asymmetric key pair may still be employed for performing the key exchange. In another embodiment, the random number used for the authentication challenge may also be used as a symmetric key if it has sufficient length (e.g., at least 128-bit).

In accordance with one embodiment, the foregoing TRFI embodiments may be implemented under an extensible firmware framework known as the Extensible Firmware Interface (EFI) (specifications and examples of which may be found at http://developer.intel.com/technology/efi). EFI is a public industry specification that describes an abstract programmatic interface between platform firmware and shrink-wrap operation systems or other custom application environments. The EFI framework includes provisions for extending BIOS functionality beyond that provided by the BIOS code stored in a platform's BIOS device (e.g., flash memory). More particularly, EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks.

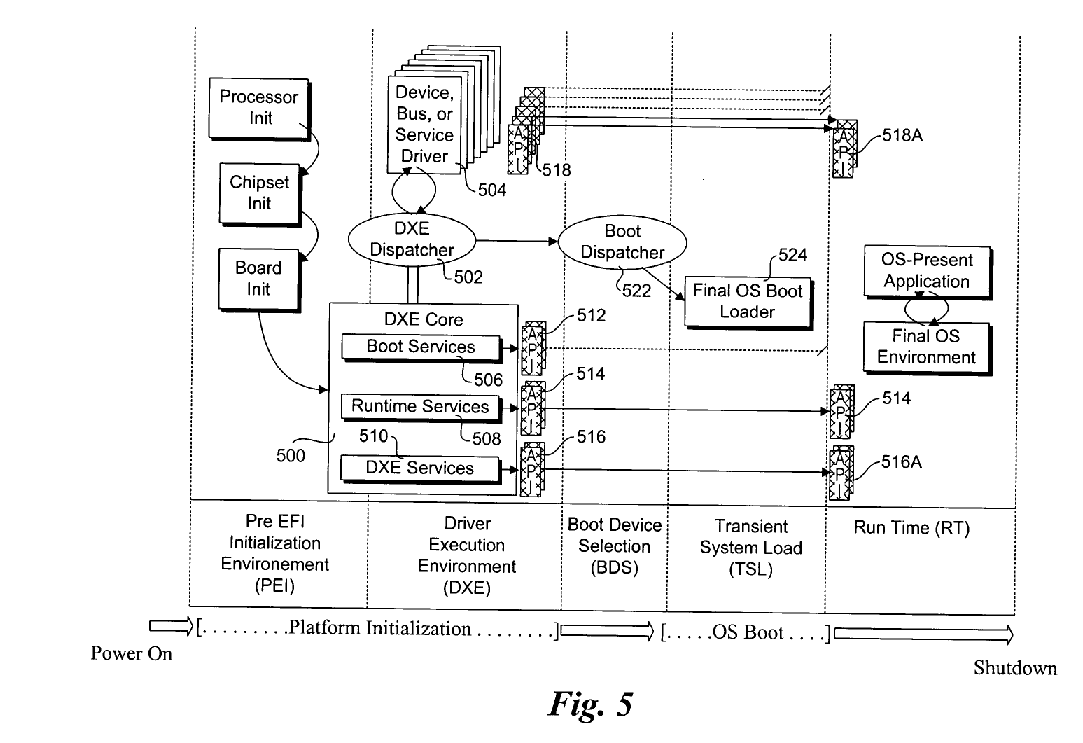

FIG. 5 shows an event sequence/architecture diagram used to illustrate operations performed by a platform under the framework in response to a restart event. While shown to illustrate initialization of a platform with a processor, the framework may be employed for initializing co-processors and related circuitry as well. The process is logically divided into several phases, including a pre-EFI Initialization Environment (PEI) phase, a Driver Execution Environment (DXE) phase, a Boot Device Selection (BDS) phase, a Transient System Load (TSL) phase, and an operating system runtime (RT) phase. The phases build upon one another to provide an appropriate run-time environment for the OS and platform.

The PEI phase provides a standardized method of loading and invoking specific initial configuration routines for the processor, chipset, and motherboard. For a co-processor, similar operations are performed in accordance with the particular hardware architecture for the system relating to the co-processor. The PEI phase is responsible for initializing enough of the system to provide a stable base for the follow on phases. Initialization of the platforms core components, including the CPU, chipset and main board (i.e., motherboard) is performed during the PEI phase. This phase is also referred to as the “early initialization” phase. Typical operations performed during this phase include the POST (power-on self test) operations, and discovery of platform resources. In particular, the PEI phase discovers memory and prepares a resource map that is handed off to the DXE phase. The state of the system at the end of the PEI phase is passed to the DXE phase through a list of position independent data structures called Hand Off Blocks (HOBs).

The DXE phase is the phase during which most of the system initialization is performed. The DXE phase is facilitated by several components, including the DXE core 500, the DXE dispatcher 502, and a set of DXE drivers 504. The DXE core 500 produces a set of Boot Services 506, Runtime Services 508, and DXE Services 510. The DXE dispatcher 502 is responsible for discovering and executing DXE drivers 504 in the correct order. The DXE drivers 504 are responsible for initializing the processor, chipset, and platform components as well as providing software abstractions for console and boot devices. These components work together to initialize the platform and provide the services required to boot an operating system. The DXE and the Boot Device Selection phases work together to establish consoles and attempt the booting of operating systems. The DXE phase is terminated when an operating system successfully begins its boot process (i.e., the BDS phase starts). Only the runtime services and selected DXE services provided by the DXE core and selected services provided by runtime DXE drivers are allowed to persist into the OS runtime environment. The result of DXE is the presentation of a fully formed EFI interface.

The DXE core is designed to be completely portable with no CPU, chipset, or platform dependencies. This is accomplished by designing in several features. First, the DXE core only depends upon the HOB list for its initial state. This means that the DXE core does not depend on any services from a previous phase, so all the prior phases can be unloaded once the HOB list is passed to the DXE core. Second, the DXE core does not contain any hard coded addresses. This means that the DXE core can be loaded anywhere in physical memory, and it can function correctly no matter where physical memory or where Firmware segments are located in the processor's physical address space. Third, the DXE core does not contain any processor-specific, chipset specific, or platform specific information. Instead, the DXE core is abstracted from the system hardware through a set of architectural protocol interfaces. These architectural protocol interfaces are produced by DXE drivers 504, which are invoked by DXE Dispatcher 502.

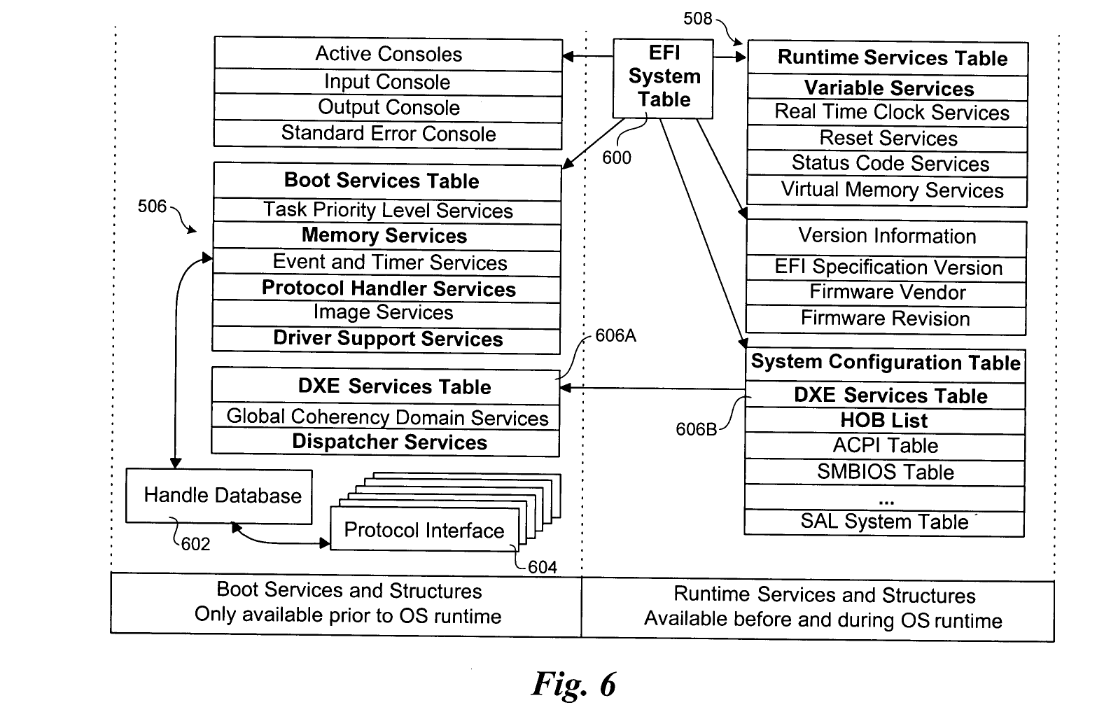

The DXE core produces an EFI System Table 600 and its associated set of Boot Services 506 and Runtime Services 508, as shown in FIG. 6. The DXE Core also maintains a handle database 602. The handle database comprises a list of one or more handles, wherein a handle is a list of one or more unique protocol GUIDs (Globally Unique Identifiers) that map to respective protocols 604. A protocol is a software abstraction for a set of services. Some protocols abstract I/O devices, and other protocols abstract a common set of system services. A protocol typically contains a set of APIs and some number of data fields. Every protocol is named by a GUID, and the DXE Core produces services that allow protocols to be registered in the handle database. As the DXE Dispatcher executes DXE drivers, additional protocols will be added to the handle database including the architectural protocols used to abstract the DXE Core from platform specific details.

The Boot Services comprise a set of services that are used during the DXE and BDS phases. Among others, these services include Memory Services, Protocol Handler Services, and Driver Support Services: Memory Services provide services to allocate and free memory pages and allocate and free the memory pool on byte boundaries. It also provides a service to retrieve a map of all the current physical memory usage in the platform. Protocol Handler Services provides services to add and remove handles from the handle database. It also provides services to add and remove protocols from the handles in the handle database. Addition services are available that allow any component to lookup handles in the handle database, and open and close protocols in the handle database. Support Services provides services to connect and disconnect drivers to devices in the platform. These services are used by the BDS phase to either connect all drivers to all devices, or to connect only the minimum number of drivers to devices required to establish the consoles and boot an operating system (i.e., for supporting a fast boot mechanism).

The DXE Services Table includes data corresponding to a first set of DXE services 606A that are available during pre-boot only, and a second set of DXE services 606B that are available during both pre-boot and OS runtime. The pre-boot only services include Global Coherency Domain Services, which provide services to manage I/O resources, memory mapped I/O resources, and system memory resources in the platform. Also included are DXE Dispatcher Services, which provide services to manage DXE drivers that are being dispatched by the DXE dispatcher.

The services offered by each of Boot Services 506, Runtime Services 508, and DXE services 510 are accessed via respective sets of API's 512, 514, and 516. The API's provide an abstracted interface that enables subsequently loaded components to leverage selected services provided by the DXE Core.

After DXE Core 500 is initialized, control is handed to DXE Dispatcher 502. The DXE Dispatcher is responsible for loading and invoking DXE drivers found in firmware volumes, which correspond to the logical storage units from which firmware is loaded under the EFI framework. The DXE dispatcher searches for drivers in the firmware volumes described by the HOB List. As execution continues, other firmware volumes might be located. When they are, the dispatcher searches them for drivers as well.

There are two subclasses of DXE drivers. The first subclass includes DXE drivers that execute very early in the DXE phase. The execution order of these DXE drivers depends on the presence and contents of an a priori file and the evaluation of dependency expressions. These early DXE drivers will typically contain processor, chipset, and platform initialization code. These early drivers will also typically produce the architectural protocols that are required for the DXE core to produce its full complement of Boot Services and Runtime Services. In one embodiment, the native drivers fall into this subclass.

The second subclass of DXE drivers are those that comply with the EFI 1.10 Driver Model. These drivers do not perform any hardware initialization when executed by the DXE dispatcher. Instead, they register a Driver Binding Protocol interface in the handle database. The set of Driver Binding Protocols are used by the BDS phase to connect the drivers to the devices required to establish consoles and provide access to boot devices. The DXE Drivers that comply with the EFI 1.10 Driver Model ultimately provide software abstractions for console devices and boot devices when they are explicitly asked to do so.

Any DXE driver may consume the Boot Services and Runtime Services to perform their functions. However, the early DXE drivers need to be aware that not all of these services may be available when they execute because all of the architectural protocols might not have been registered yet. DXE drivers must use dependency expressions to guarantee that the services and protocol interfaces they require are available before they are executed.

The DXE drivers that comply with the EFI 1.10 Driver Model do not need to be concerned with this possibility. These drivers simply register the Driver Binding Protocol in the handle database when they are executed. This operation can be performed without the use of any architectural protocols. In connection with registration of the Driver Binding Protocols, a DXE driver may “publish” an API by using the InstallConfigurationTable function. These published drivers are depicted by API's 518. Under EFI, publication of an API exposes the API for access by other firmware components. The API's provide interfaces for the Device, Bus, or Service to which the DXE driver corresponds during their respective lifetimes.

The BDS architectural protocol executes during the BDS phase. The BDS architectural protocol locates and loads various applications that execute in the pre-boot services environment. Such applications might represent a traditional OS boot loader, or extended services that might run instead of, or prior to loading the final OS. Such extended pre-boot services might include setup configuration, extended diagnostics, flash update support, OEM value-adds, or the OS boot code. A Boot Dispatcher 520 is used during the BDS phase to enable selection of a Boot target, e.g., an OS to be booted by the system.

During the TSL phase, a final OS Boot loader 522 is run to load the selected OS. Once the OS has been loaded, there is no further need for the Boot Services 506, and for many of the services provided in connection with DXE drivers 504 via API's 518, as well as DXE Services 606A. Accordingly, these reduced sets of API's that may be accessed during OS runtime are depicted as API's 516A, and 518A in FIG. 5.

The EFI framework of FIGS. 5 and 6 enables firmware services provided by various DXE drivers to be accessed via calls to the API's corresponding to those services and/or drivers. This callable API scheme enables agents, including both software and firmware agents, to access the firmware services. Depending on the particular service required, a requested service may be performed during pre-boot and/or OS runtime. Furthermore, under TRFI, firmware services may be requested via remote calls to corresponding API's.

Further details of remote firmware service access aspects of the invention, as depicted by the operation of block 236 discussed above, are delineated in the flowchart of FIG. 5. The process begins in a block 500, wherein a request packet is received from a caller computer by the remote computer. In response to receiving the request packet, it is processed by the remote computer in a block 502. The request packet contains one or more tasks for the remote to perform. As described below, a task includes instructing the firmware to execute code stored on the remote or another computer accessible to the remote. A task may also include providing the remote computer with code in the request packet for the remote to execute. In one embodiment, if the request packet contains a plurality of separate tasks for the firmware to perform, then the firmware returns one response packet that includes a response for each of the plurality of assigned tasks.

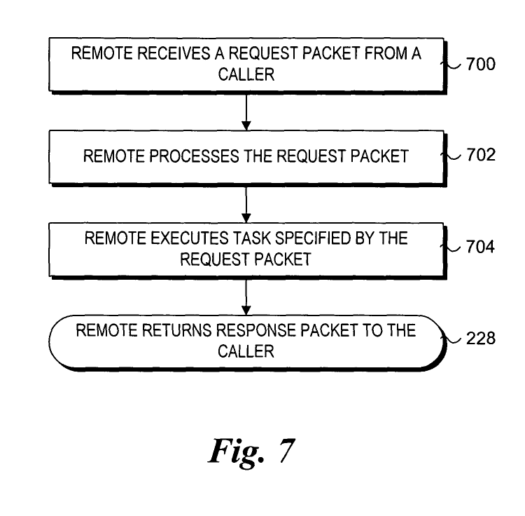

It will be appreciated that TRFI allows for interrogation of a remote machine without the necessity of constructing a pre-defined binary image for the task. In one embodiment, scripting is initiated from a caller computer. A scripting language is a high-level programming language that is interpreted instead of compiled before execution. This is different from pushing code to run on a remote computer because once the program is running on the remote, the caller usually cannot interrupt the process. With the TRFI mechanism, the caller computer is not limited to pre-defined capabilities that are stored on the remote computer, such as in a PXE ROM (PreBoot Execution Environment Read-Only Memory). TRFI enables flexibility in interacting with the remote system as if an operator was writing code line-by-line while the remote is running. This interaction is performed at the firmware level and independent of an operating system of the remote computer. In one embodiment of an EFI-compliant system, a scripting language is used to interrogate a remote computer to determine what protocols are available to the remote. Using this information, the remote is instructed to perform a task using a particular protocol. In another embodiment, after using the scripting language to determine what protocols are stored on the remote computer, the caller computer loads a driver onto the remote computer. The caller computer then tells the remote computer to install the protocol corresponding to the driver, such as by issuing an InstallProtocollnterface command. Further details of a firmware framework for supporting this functionality is described below with reference to FIGS. 6 and 7.

In one embodiment, the remote's firmware analyzes the request packet header to determine what type of request packet was sent. In one embodiment in an EFI-compliant system, such a packet header is defined as follows:

| | | |
|---|---|---|
| typedef struc { | | |
| EFI_GUID | PacketDefinition; | //what type of packet? |
| UINTN | PacketLength; | //size of the entire packet |
| //UINT8 | PacketData[ ] | //packet data |

} PACKET_HEADER;

One type of request packet is a firmware interface packet. An interface packet is used to call a pre-defined function available to the firmware of the remote computer. In an EFI-compliant system embodiment, an interface packet includes a request to run a protocol interface function. An embodiment of an interface packet of an EFI-compliant system is defined as follows:

| | | |
|---|---|---|
| typedef struc { | | |
| EFI_GUID | InterfaceType; | //which protocol? |
| //UINT8 | Parameters[ ]; | //parameter stack |

} INTERFACE_PACKET;

Another type of request packet is a memory packet to access a memory address of the remote computer. One embodiment of an interface packet is defined as follows:

| | | |
|---|---|---|
| typedef struc { | | |
| UINTN | Address; | //what memory address? |
| BOOLEAN | Write; | //TRUE = write memory |
| | | //FALSE = read memory |
| UINTN | BufferSize; | //size of the packet buffer |
| //UINT8 | Buffer[ ]; | //buffer to read/write |

} MEMORY_PACKET;

Another type of request packet is a data structure packet to access data contained in a data structure accessible by the firmware of the remote computer. In an embodiment of an EFI-compliant system, the data structure packet is used to access the data maintained in an EFI table. In one embodiment, a table packet is defined as follows:

| | | |
|---|---|---|
| typedef struc { | | |
| TABLE_TYPE | WhichTable; | //enum of tables |
| CHILD_TYPE | TableEntry; | //enum of table entries |
| SUBCHILD_TYPE | TableEntry; | //enum of table entries |
| //UINT8 | Parameters[ ]; | //parameter stack |

} TABLE_PACKET;

After the remote processes the request packet in block 702, the task requested by the request packet is executed by the remote's firmware, as illustrated in a block 704. After completion of the task, the remote prepares and returns a response packet to the caller computer, as depicted in block 228. In one embodiment, if the remote is unable to complete a task requested by a caller, the remote will return a request packet containing an error message for the caller. In one embodiment, such an error message includes a notice that the assigned task has failed and information as to the source of the error.

FIG. 8 illustrates an embodiment of an exemplary computer system 800 to practice embodiments of the invention described above. Computer system 800 is generally illustrative of various types of computer devices, including personal computers, laptop computers, workstations, servers, etc. For simplicity, only the basic components of the computer system are discussed herein. Computer system 800 includes a chassis 802 in which various components are housed, including a floppy disk drive 804, a hard disk 806, a power supply (not shown), and a motherboard 808. Hard disk 806 may comprise a single unit, or multiple units, and may optionally reside outside of computer system 800. The motherboard 808 includes a memory 810 coupled to one or more processors 812. Memory 810 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 812 may be a conventional microprocessor including, but not limited to, a CISC processor, such as an Intel Corporation x86, Pentium, or Itanium family microprocessor, a Motorola family microprocessor, or a RISC processor, such as a SUN SPARC processor or the like.

The computer system 800 also includes a non-volatile memory device on which firmware is stored. Such non-volatile memory devices include a ROM device 820 or a flash device 822. Other non-volatile memory devices include, but are not limited to, an Erasable Programmable Read Only Memory (EPROM), an Electronically Erasable Programmable Read Only Memory (EEPROM), or the like. The computer system 800 may include other firmware devices as well (not shown).

A monitor 414 is included for displaying graphics and text generated by firmware, software programs and program modules that are run by computer system 800, such as system information presented during system boot. A mouse 816 (or other pointing device) may be connected to a serial port, USB (Universal Serial Bus) port, or other like bus port communicatively coupled to processor 812. A keyboard 818 is communicatively coupled to motherboard 808 in a similar manner as mouse 816 for user entry of text and commands. In one embodiment, computer system 800 also includes a network interface card (NIC) or built-in NIC interface (not shown) for connecting computer system 400 to a computer network 830, such as a local area network (LAN), wide area network (WAN), or the Internet. In one embodiment network 830 is further coupled to a remote computer 835, such that computer system 800 and remote computer 835 can communicate. In one embodiment, a portion of the computer system's firmware is loaded during system boot from remote computer 835.

The illustrated embodiment further includes an optional add-in card 824 that is coupled to an expansion slot of motherboard 808. In one embodiment, add-in card 824 includes an Option ROM 826 on which firmware is stored. Computer system 800 may also optionally include a compact disk-read only memory (“CD-ROM”) drive 828 into which a CD-ROM disk may be inserted so that executable files, such as an operating system, and data on the disk can be read or transferred into memory 810 and/or hard disk 806. Other mass memory storage devices may be included in computer system 800.

In another embodiment, computer system 800 is a handheld or palmtop computer, which are sometimes referred to as Personal Digital Assistants (PDAs). Handheld computers may not include a hard disk or other mass storage, and the executable programs are loaded from a corded or wireless network connection into memory 810 for execution by processor 812. A typical computer system 800 will usually include at least a processor 812, memory 810, and a bus (not shown) coupling the memory 810 to the processor 812.

It will be appreciated that in one embodiment, computer system 800 is controlled by operating system software that includes a file management system, such as a disk operating system, which is part of the operating system software. For example, one embodiment of the present invention utilizes Microsoft Windows® as the operating system for computer system 800. In another embodiment, other operating systems such as, but not limited to, an Apple Macintosh operating system, a Linux-based operating system, the Microsoft Windows CE® operating system, a Unix-based operating system, the 3Com Palm operating system, or the like may also be use in accordance with the teachings of the present invention.

Thus, embodiments of this invention may be used as or to support a firmware and software code executed upon some form of processing core (such as processor 812) or otherwise implemented or realized upon or within a machine-readable medium. A machine-readable medium includes any mechanism that provides (i.e., stores and/or transmits) information in a form readable by a machine (e.g., a computer, network device, personal digital assistant, manufacturing tool, any device with a set of one or more processors, etc.). In to recordable media, such as disk-based media, a machine-readable medium may include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method, comprising:
issuing, via a caller computer, a request to have a firmware service be performed via firmware on a remote computer
authenticating the caller computer; and
performing the firmware service if the caller computer is authenticated, otherwise denying access to the firmware service.

2. The method of claim 1, further comprising initializing a listening mechanism on the remote computer to receive the request.

3. The method of claim 2, wherein the listening mechanism is interrupt-based, further comprising asserting an interrupt on a processor of the remote computer in response to receiving the request.

4. The method of claim 2, wherein the listening mechanism is polling-based, further comprising periodically polling a network interface of the remote computer to determine if the remote computer has received a request.

5. The method of claim 1, wherein the caller computer is authenticated by performing operations including:
issuing an authentication challenge to the caller computer; and
evaluating a response by the caller computer to the authentication challenge.

6. The method of claim 5, wherein the operations further include:
encrypting original data using a first key held by the remote computer to create encrypted original data;
sending the encrypted original data to the calling computer;
decrypting the encrypted original data using a second key held by the caller computer to create decrypted data;
sending the decrypted data back to the remote computer;
comparing the decrypted data with the original data to authenticate the calling computer.

7. The method of claim 6, further comprising extracting the first key from an authentication certificate for the caller computer issued to the remote computer.

8. The method of claim 7, wherein the first key is an public key contained in the authentication certificate and the second key comprises a private key held by the calling computer that is the asymmetric key for the public key.

9. The method of claim 1, further comprising:
issuing at least one authentication certificate to the remote computer, each of said at least one authentication certificate containing authentication information corresponding to a respective caller computer;
receiving authentication credentials from a caller computer;
authenticating the caller computer via the authentication credentials in view of a corresponding authentication certificate from among said at least one authentication certificate issued to the remote computer.

10. The method of claim 9, further comprising determining if an authentication certificate corresponding to the caller computer has expired.

11. The method of claim 9, further comprising determining if an authentication certificate corresponding to the caller computer has been revoked.

12. The method of claim 1, further comprising authenticating the remote computer.

13. The method of claim 1, further comprising sending encrypted traffic relating to the firmware service request and results of the request between the caller computer and the remote computer.

14. The method of claim 13, further comprising performing a cipher negotiation between the caller computer and the remote computer to agree upon an encryption technique used to encrypt and decrypt the encrypted traffic.

15. The method of claim 14, wherein the encryption technique employs at least one session key.

16. The method of claim 1, wherein communications between the caller computer and the remote computer are performed using an out-of-band communication channel that operates independent of an operating system to run or running on the remote computer.

17. An article of manufacture, comprising:
a machine-readable medium on which a plurality of instructions are stored, which when executed perform operations comprising:
receive a request from a caller computer to perform a firmware service;
authenticate the caller computer; and
perform the firmware service if the caller computer is authenticated,
otherwise denying access to the firmware service.

18. The article of manufacture of claim 17, wherein execution of the plurality of instructions further performs the operation of initializing a listening mechanism to receive the request.

19. The article of manufacture of claim 17, wherein execution of the plurality of instructions further performs operations including:
issuing an authentication challenge to the caller computer;
receiving a response to the authentication challenge from the caller computer; and
evaluating the response to determine whether the caller computer is authenticate.

20. The article of manufacture of claim 19, wherein evaluating the response to the authentication challenge comprises:
extracting authentication credentials for the caller computer contained in the response;
identifying an authentication certificate corresponding to the caller computer; and
checking authentication credentials for the caller computer against the authentication certificate that is identified.

21. The article of manufacture of claim 20, wherein execution of the plurality of instructions further performs the operation of determining if the authentication certificate that is identified has expired.

22. The article of manufacture of claim 20, wherein execution of the plurality of instructions further performs the operation of determining if the authentication certificate that is identified has been revoked.

23. The article of manufacture of claim 19, wherein execution of the plurality of instructions performs further operations including:
generating a random number;
encrypting the random number using a first key to create an encrypted random number;
sending the encrypted random number to the calling computer;
receiving decrypted data derived from the encrypted random number from the calling computer
comparing the decrypted data with the random number to authenticate the calling computer.

24. The article of manufacture of claim 17, wherein the article comprises a firmware storage device and the plurality of instructions comprise firmware.

25. The article of manufacture of claim 17, wherein execution of the plurality of instructions further performs the operation of performing a cipher negotiation between the caller computer and a remote computer on which the plurality of instructions are executed to agree upon an encryption technique to be used to encrypt and decrypt encrypted traffic to be sent between the caller computer and the remote computer.

26. The article of manufacture of claim 25, wherein the encryption technique employs a shared asymmetric session key.

27. A computer system, comprising:
a processor;
a memory, operatively coupled to the processor;
a network interface operatively coupled to the processor; and
at least one flash device operatively coupled to the processor on which firmware instructions are stored, which when executed by the processor perform operations comprising:
receive a request to perform a firmware service received from a caller computer via the network interface;
authenticate the caller computer; and
perform the firmware service if the caller computer is authenticated, otherwise denying access to the firmware service

28. The computer system of claim 27, wherein execution of the firmware instructions performs the further operation of periodically polling the network interface to determine if the network interface has received a request from a caller computer to perform a firmware service.

29. The computer system of claim 27, wherein execution of the firmware instructions performs further operations, including:
issuing an authentication challenge to the caller computer;
receiving a response to the authentication challenge from the caller computer; and
evaluating the response to determine whether the caller computer is authenticate.

30. The computer system of claim 27, wherein execution of the firmware instructions further performs the operation of performing a cipher negotiation between the caller computer and the computer system to agree upon an encryption technique to be used to encrypt and decrypt encrypted traffic to be sent between the caller computer and the computer system.
